(19) United States
(12) Patent Application Publication
(10) Pub. No.: US 2022/0202119 A1
(43) Pub. Date: Jun. 30, 2022

(54) Spydy Light Gloves

(71) Applicant: Moiese Williams, Riverdale, GA (US)

(72) Inventor: Moiese Williams, Riverdale, GA (US)

(21) Appl. No.: 17/138,880

(22) Filed: Dec. 30, 2020

(51) Int. Cl. A41D 19/015; F21V 33/00

(52) U.S. Cl. CPC A41D 19/0157; F21Y 2115/10; F21V 33/0008

(57) ABSTRACT

An article of manufacture with several rows of lights extending up each finger is disclosed. The article of manufacture provides a wearable work light using a glove for use on a thumb and fingers of a worker's hand, and an enclosed casing coupled to the outside of the glove containing an enclosed circuit. The enclosed circuit includes a battery with anode and cathode terminals for energizing an enclosed circuit, a switch having an open position and a closed position connecting the cathode terminal of the battery to the enclosed circuit, one or more power lines connecting the anode terminal of the battery to positive input connections to a plurality of LEDs electrically coupled to one of the power lines, and a return line connecting the negative connections of the plurality of LEDs to the switch. The plurality of LEDs is energized to emit light when the switch is in its closed position.

### CROSS-REFERENCE TO RELATED APPLICATION

This application claims priority to U.S. Patent Application No. 62/966,472, titled “Work Gloves with Integrated Light Sources,” and filed on Jan. 27, 2020. The entire application is incorporated herein by reference in its entirety.

### TECHNICAL FIELD

This application relates in general to an article of manufacture for providing lighting systems, and more specifically, to an article of manufacture for providing a lighting system for hands-free use by mechanics, maintenance personnel, and similar workers.

### BACKGROUND

Maintenance personnel and/or mechanics have traditionally used hand-held or mounted flashlights to see or work in dark spaces. These light sources typically are not hands-free and thus it's difficult to work, especially in tight spaces, while holding a light source. The loss of the use of a hand or loss of light in an enclosed workspace reduces the efficiencies of workers of all types.

Therefore, a need exists for an article of manufacture for providing a lighting system for hands-free use by mechanics, maintenance personnel, and similar workers. The present invention attempts to address the limitations and deficiencies in prior solutions according to the principles and example embodiments disclosed herein.

### SUMMARY

In accordance with the present invention, the above and other problems are solved by providing an article of manufacture for a lighting system for hands-free use by mechanics, maintenance personnel, and similar workers according to the principles and example embodiments disclosed herein.

In one embodiment, the present invention is an article of manufacture for providing a lighting system for hands-free use. The article of manufacture provides a wearable work light using a glove for use on a thumb and fingers of a worker's hand and an enclosed casing coupled to the outside of the glove containing an enclosed circuit. The enclosed circuit includes a battery having anode and cathode terminals for energizing an enclosed circuit, a switch having an open position and a closed position connecting the cathode terminal of the battery to the enclosed circuit, one or more power lines connecting the anode terminal of the battery to positive input connections to a plurality of LEDs electrically coupled to one of the power lines, and a return line connecting the negative connections of the plurality of LEDs to the switch. The plurality of LEDs is energized to emit light when the switch is in its closed position.

In another aspect of the present disclosure, the enclosed casing is oriented about the sides of the glove and along an outside surface of the fingers of the glove and the plurality of LEDs is positioned along the length of the enclosed casing.

In another aspect of the present disclosure, a plurality of separate enclosed casings each having a portion of the plurality of LEDs are independently connected to the anode of the battery.

In another aspect of the present disclosure, each of the separate enclosed casings has a switch for energizing the portion of the plurality of LEDs independently from each other.

In another aspect of the present disclosure the enclosed casings are sewn to the glove.

In another aspect of the present disclosure the glove covers only a portion of the fingers and a portion of the thumb exposing the fingertips.

In another aspect of the present disclosure the enclosed casing is further positioned across a palm of the glove about a wrist strap coupled to the glove.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only, and is not intended as a definition of the limits of the present invention.

### BRIEF DESCRIPTION OF THE DRAWINGS

Referring now to the drawings in which like reference numbers represent corresponding parts throughout:

FIG. 1 illustrates an example embodiment for an article of manufacture with several rows of lights extending up each finger according to the present invention.

FIG. 2 illustrates a close-up view of a palm of a hand from an article of manufacture with rows of lights extending up each finger according to the present invention.

FIG. 3 illustrates a close-up view of a thumb and forefinger from an article of manufacture with rows of lights extending up each finger according to the present invention.

FIG. 4 illustrates a side view of an article of manufacture with rows of lights extending up each finger according to the present invention.

FIG. 5 illustrates a circuit diagram of an article of manufacture with rows of lights extending up each finger according to the present invention.

### DETAILED DESCRIPTION

This application relates in general to an article of manufacture for providing lighting systems, and more specifically, to an article of manufacture for providing a lighting system for hands-free use according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. Thus, for example, reference to “a needle” includes reference to one or more of such needles and “etching” includes one or more of such steps. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

The terms “worker,” and “user” refer to an entity, e.g. a human, using the lighted gloves associated with the invention. The term user herein refers to one or more users.

The term “invention” or “present invention” refers to the invention being applied for via the patent application with the title “Work Gloves with Integrated Light Sources.” Invention may be used interchangeably with lighted gloves.

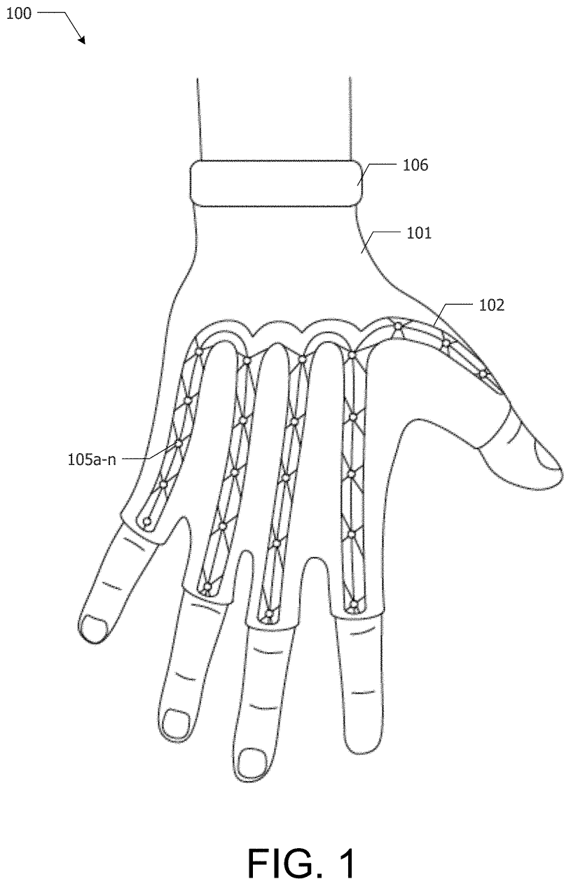

In general, the present disclosure relates to an article of manufacture for providing lighting systems. To better understand the present invention, FIG. 1 illustrates an example embodiment for an article of manufacture with several rows of lights extending up each finger according to the present invention. The lighted glove 101 provides a user with hands-free illumination. The lighted glove 101 can be used to be able to work and see in small, tight, spaces without having to hold or mount a light or flashlight. The lighted glove 101 may eliminate any shadows or dark areas that may need to be illuminated where traditional lighting will not reach. In embodiments, the ability to place one finger in a darkened space and illuminate the dark space is provided.

The lighted glove 101, in one embodiment, is a half-finger durable work glove that has one or more streams of light on the top or back hand of the glove optionally starting from the wrist. The one or more streams of light may extend out separately and over each finger to the end of the glove. The lights may be LEDs. The LED at the end of a glove's finger surface area may point forward beyond the user's fingertips for use as a mini flashlight.

The lighted glove 101 may function as an uninhibited work light wrapped around the user's hand. In embodiments, the product's battery 201 on and off button may be located inside of the wrist strap.

The lighted glove 101 may provide the user direct hands-free illumination in small, tight spaces where only a hand and or a tool will fit without having to hold or may be strategically positioned on the palm to allow the glove to emit light from the palm side even with a closed first gripping or holding a tool. The LEDs may be partially seated in a protective, durable, flexible material of the enclosed casing 102. The LEDs 105a-n are typically positioned far enough above the center of a worker's palm and along an outside surface of the fingers as to not routinely come into contact with an item or tool while being gripped by the worker.

The product may be worn over the top of widely used nitrile industrial gloves or similar latex gloves. The product's work-light glove will not restrict the user's ability to grasp, hold, or use very small items or tools.

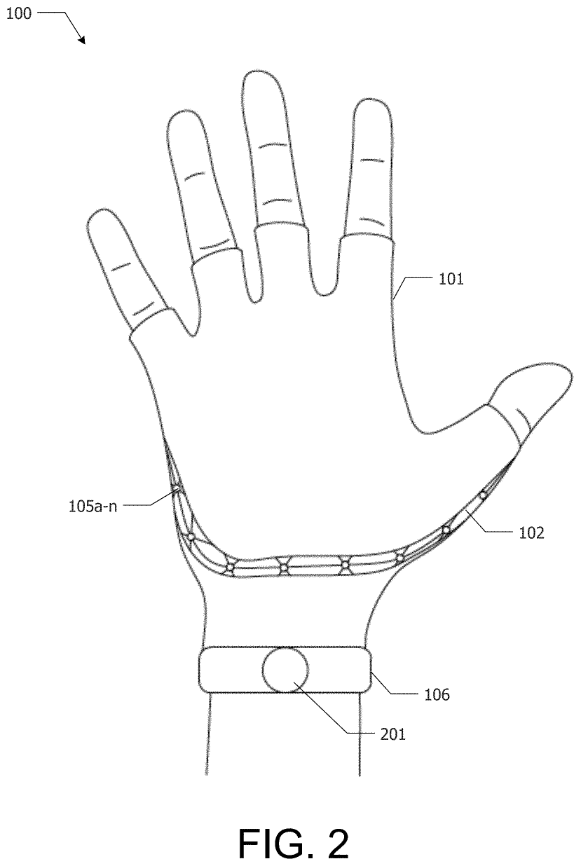

FIG. 2 illustrates a close-up view of a palm of a hand from an article of manufacture with rows of lights extending up each finger according to the present invention. The palm side of the glove may have LEDs positioned across the base or bottom of the palm near the wrist from one side of the palm to the other side. The lights may continue up the outer side of the thumb and the outer edge of the pinky finger. Circuitry may be sewn or otherwise coupled to the lighted glove 101, typically within an enclosed casing 102. A series of LEDs 105a-n may be located along the enclosed casing with the light-emitting portion extending outward from the casing.

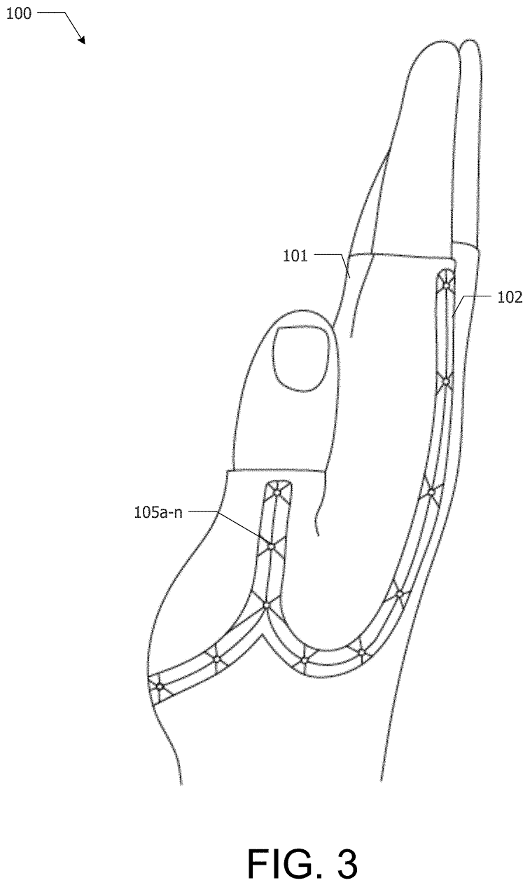

FIG. 3 illustrates a close-up view of a thumb and forefinger from an article of manufacture having rows of lights extending up each finger according to the present invention. The rows of LEDs 105a-n also may be positioned along the sides of the lighted glove 101 to attempt to maximize the amount of light emitted within an enclosed workspace.

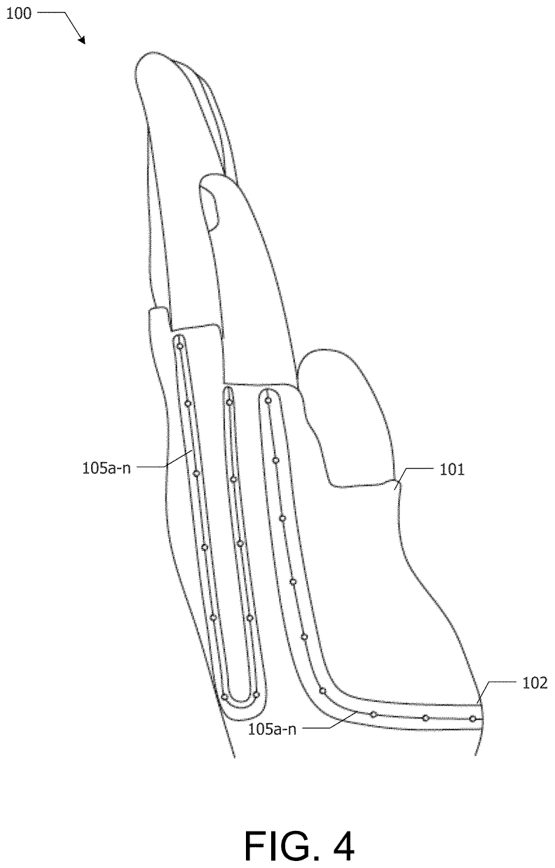

FIG. 4 illustrates a side view of an article of manufacture having rows of lights extending up each finger according to the present invention. The circuit enclosed within the enclosed casing 102 may comprise a continuous enclosure to permit a single parallel circuit of LEDs 105a-n to be arranged about the lighted glove. In alternate embodiments, the enclosed casing 102 may include multiple enclosed casings 102 that all begin about the wrist permitting each of the circuits of LEDs to be electrically connected to the battery 201.

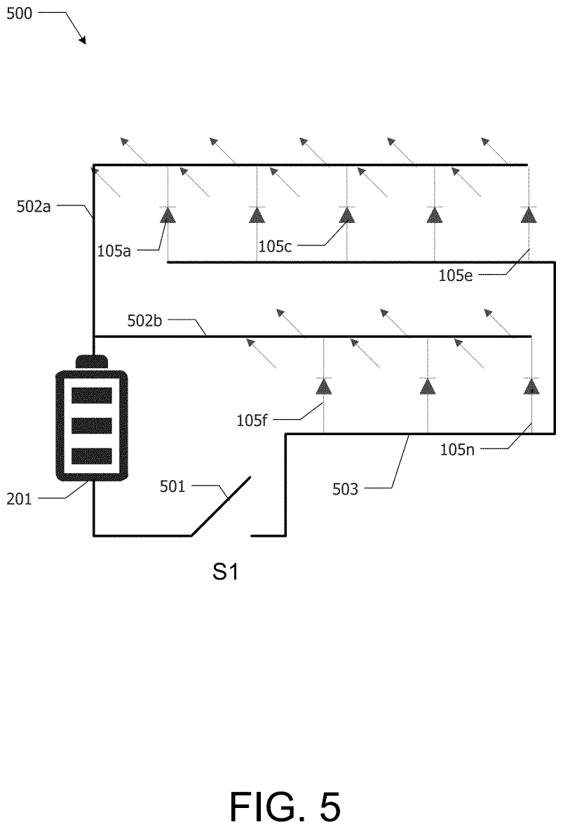

FIG. 5 illustrates a circuit diagram of an article of manufacture having rows of lights extending up each finger according to the present invention. The circuit 500 of the lighted glove 101 begins with a battery 201 having one or more positive power lines 502a-b running from the battery anode to each of the positive connections to the set of LEDs 105a-n about the lighted glove.

A return line 503 connects to a first terminal of switch S1 501 to all of the negative connections of the set of LEDs 105a-n about the lighted glove 101. The switch's S1 501 second terminal is connected to the cathode of the battery 201. When the switch S1 501 is closed, the circuit 500 is completed and the battery 201 provides an electrical charge to energize the set of LEDs 105a-n about the lighted glove 101. Of course, in alternate embodiments, more than one switch (not shown) may be used to separately power the one or more power lines 502a-b independently to control the amount of illumination generated by the lighted glove 101. Additionally, a potentiometer (not shown) may be positioned in series with the switch S1 501 to regulate the amount of voltage provided to the set of LEDs 105a-n about the lighted glove 101 to attempt to control the amount of illumination emitted by the glove.

Even though particular combinations of features are recited in the present application, these combinations are not intended to limit the disclosure of the invention. In fact, many of these features may be combined in ways not specifically recited in this application. In other words, any of the features mentioned in this application may be included to this new invention in any combination or combinations to allow the functionality required for the desired operations.

No element, act, or instruction used in the present application should be construed as critical or essential to the invention unless explicitly described as such. Further, the phrase “based on” is intended to mean “based, at least in part, on” unless explicitly stated otherwise.

What is claimed is:

1. An article of manufacture for providing a wearable work light, the article comprises:
a glove for use on a thumb and fingers of a worker's hand; and
an enclosed casing coupled to the outside of the glove containing an enclosed circuit, the enclosed circuit comprises:
a battery having an anode and cathode terminal for energizing an enclosed circuit;
a switch having an open position and a closed position connecting the cathode terminal of the battery to the enclosed circuit;
one or more power lines connecting the anode terminal of the battery to positive input connections to a plurality of LEDs electrically coupled to one of the power lines; and
a return line connecting the negative connections of the plurality of LEDs to the switch;
wherein the plurality of LEDs is energized to emit light when the switch is in its closed position.

2. The article of manufacture according to claim 1, wherein the enclosed casing is oriented about the sides of the glove and along an outside surface of the fingers of the glove; and
the plurality of LEDs is positioned along the length of the enclosed casing.

3. The article of manufacture according to claim 1, wherein a plurality of separate enclosed casings each having a portion of the plurality of LEDs are independently connected to the anode of the battery.

4. The article of manufacture according to claim 3, wherein each of the separate enclosed casings has a switch for energizing the portion of the plurality of LEDs independently from each other.

5. The article of manufacture according to claim 1, wherein the enclosed casings are sewn to the glove.

6. The article of manufacture according to claim 5, wherein the glove covers only a portion of the fingers and a portion of the thumb exposing the fingertips.

7. The article of manufacture according to claim 1, wherein the enclosed casing is further positioned across a palm of the glove about a wrist strap coupled to the glove.
